(19) United States
(12) Patent Application Publication
(10) Pub. No.: US 2021/0229841 A1
(43) Pub. Date: Jul. 29, 2021

(54) ORBITAL DELIVERY SYSTEM AND METHOD

(71) Applicant: ABL Space Systems, El Segundo, CA (US)

(72) Inventors: Harrison O'Hanley, El Segundo, CA (US); Daniel Piemont, El Segundo, CA (US); Andrew Michael Keller-Goralczyk, Arlington, VA (US)

(21) Appl. No.: 17/156,183

(22) Filed: Jan. 22, 2021

Related U.S. Application Data
(60) Provisional application No. 62/964,912, filed on Jan. 23, 2020.

(51) Int. Cl. B64G 1/62

(52) U.S. Cl. CPC B64G 1/62; B64G 1/46

(57) ABSTRACT

An orbital delivery system includes a exo-atmospheric system arranged along an orbital or sub-orbital trajectory. The exo-atmospheric system includes a propulsion system to adjust an orientation responsive to a signal to begin a reentry procedure. During the reentry procedure, a deployment system is activated to engage an atmospheric landing system to direct a payload toward a landing location.

### CROSS REFERENCE TO RELATED APPLICATIONS

This application claims priority to and the benefit of co-pending U.S. Provisional Application Ser. No. 62/964,912 filed Jan. 23, 2020 titled “PRECISION ORBITAL DELIVERY SYSTEM”, the full disclosure of which is hereby incorporated herein by reference in its entirety for all purposes.

### BACKGROUND

Existing methods to deliver cargo may include land, air, sea, or a combination of methods to move units from a first position to a second position. Often, these methods may have long lead times and delivery may be complicated by a variety of factors, such as environmental or political events within various regions. Systems and methods to bypass these problems, such as air drops, do not overcome these challenges and present a host of new problems, including personnel exposure to potentially hazardous conditions, limited ranges, and long lead times due to limited speed.

### BRIEF DESCRIPTION OF THE DRAWINGS

Various embodiments in accordance with the present disclosure will be described with reference to the drawings, in which:

FIG. 1 is a schematic diagram of an embodiment of an orbital delivery system, in accordance with embodiments of the present disclosure;

FIG. 2 is a schematic diagram of an embodiment of an exo-atmospheric system, in accordance with embodiments of the present disclosure;

FIG. 3 is a schematic diagram of an embodiment of an atmospheric control system, in accordance with embodiments of the present disclosure;

FIG. 4 is a schematic diagram of a delivery sequence, in accordance with embodiments of the present disclosure;

FIG. 5 is a flow chart of an embodiment of method for orbital delivery, in accordance with embodiments of the present disclosure; and

FIG. 6 is a flow chart of an embodiment of method for deployment stage activation, in accordance with embodiments of the present disclosure.

### DETAILED DESCRIPTION

Systems and methods in accordance with various embodiments of the present disclosure may overcome one or more of the aforementioned and other deficiencies experienced in conventional approaches for cargo delivery systems.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, “other embodiments”, or “various embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Furthermore, when describing certain features that may be duplicative between multiple items, the features may be designated with similar reference numerals followed by a corresponding identifier, such as “A” or “B”.

In various embodiments, systems and methods are utilized for cargo delivery. In at least one embodiment, systems and methods are directed to a space based, precision orbital or sub-orbital cargo delivery system. In this system, cargo is loaded into one or more exo-atmospheric systems, which may be referred to as a capsule, that is placed on top of a space launch vehicle. The capsule is outfitted with an atmospheric landing system, such as a precision, steerable parachute system, among various other options. The launch vehicle launches the capsule into space on either an orbital or sub-orbital trajectory. The capsule renters the atmosphere and uses an onboard heat shield to reduce velocity. Subsequently, the capsule deploys a steerable parachute system to guide it to the final landing point, in at least one embodiment. Embodiments may enable rapid and accurate cargo delivery to a specified location. This cargo could include, but is not limited to, medical supplies, vehicles, munitions, unmanned vehicles, equipment or other material.

Various embodiments of the present disclosure include an integrated capsule system that is comprised of a space cargo capsule that can carry and protect cargo in launch, space, and reentry environments. The interior of the capsule may be pressurized, heated, or otherwise conditioned to protect the contents of the cargo. The capsule has a variable cargo volume that is particularly selected based, at least in part, on capabilities of the launch vehicle. As one non-limiting example, cargo volume is approximately 30 cubic feet. Moreover, capacity for the capsule may be based, at least in part, on capabilities of the launch vehicle. As one non-limiting example, cargo capacity is approximately 2,400 pounds. It should be appreciated that alternate embodiments of the capsule may include larger or smaller variants. The capsule may include an onboard propulsion system that enables maneuverability while in orbit, to position the capsule into orbit, to facilitate a de-orbit to reenter earth's atmosphere, and/or to facilitate directing the capsule to a landing location. The propulsion system may be inert cold gas, monopropellant, bi-propellant, or other forms of propulsion. In at least one embodiment, the capsule has a precision navigation system that includes global positioning system (GPS), inertial measurement units, star trackers, and/or other forms of navigation sensing. The capsule may further include a deployable, steerable parachute system that can be actuated to guide the capsule to a precise landing zone. It should be appreciated that other reentry and landing systems may also be utilized in combination with, or in place of, one or more parachute systems, among other landing vehicles. In at least one embodiment, the capsule is launched into space using a launch vehicle and the capsule may be launched into orbit and remain in orbit for an indefinite amount of time prior to de-orbiting. Using onboard communication systems, the capsule can communicate with ground or satellite systems and can be commanded to reenter at a designated time following launch. The capsule may use an onboard propulsion system to deorbit and begin reentry maneuvers. Alternatively, the capsule may be launched on a sub-orbital trajectory and enter space briefly before reentering the atmosphere and deploying one or more atmospheric landing systems, such as parachute(s), that can be steered to achieve a precise landing.

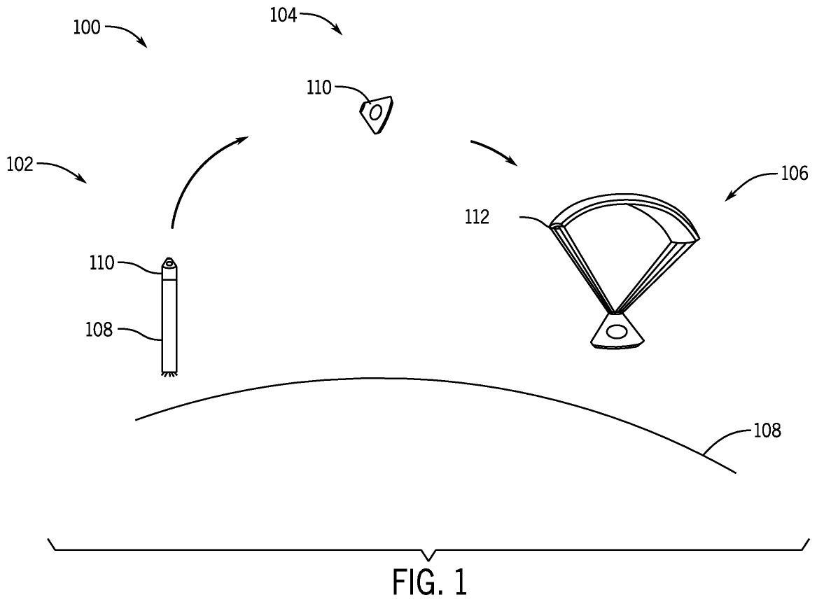

FIG. 1 is a schematic diagram of an embodiment of an orbital delivery system 100. In this embodiment, the systems include a first phase 102 that represents a launch or positioning phase, a second phase 104 that represents an orbital or sub-orbital phase, and a third phase 106 that represents an atmospheric phase. Each phase may utilize one or more components of the system in order to enable orbital delivery.

In this example, the first phase 102 includes a launch vehicle 108 and an exo-atmospheric system (EAS) 110. The EAS 110 may include one or more types of vehicles that are particularly selected for use with a launch vehicle 108. In embodiments, the EAS 110 includes one or more of a capsule, a lifting body, an inflatable reentry vehicle (IRV), a maneuverable reentry vehicle (MARV), or multiple independently targetable reentry vehicles (MIRV). Furthermore, combinations of these systems may also be utilized. For example, a single capsule may include multiple IRVs or MARVs. For simplicity, the EAS 110 is illustrated as a capsule with a substantially frustoconical shape or blunt cone body. In various embodiments, the EAS 110 is secured to the launch vehicle 110, such as a rocket, and is launched into space or sub-space atmospheres.

As shown in FIG. 1, the second phase 104 illustrates the EAS 110 after detaching from the launch vehicle 108 positioned in an orbital or sub-orbital trajectory. It should be appreciated that the EAS 110 may include one or more propulsion systems that enable positioning and/or maneuvering for orbit and/or reentry procedures. Furthermore, as will be described below, various additional systems and sub-systems may enable positioning and operation of the EAS 110 within the orbital or sub-orbital trajectory.

Upon receipt of instructions or after a period of time, the EAS 110 reenters the atmosphere for the third phase 106. In this example, the EAS 110 may utilize one or more propulsion systems in order to maneuver into position for reentry, which may include positioning one or more heat shields at particularly selected locations and/or positioning a bottom of the EAS 110 toward the earth in order to slow or reduce a speed upon entry. In this example, an atmospheric landing system (ALS) 112 is utilized to guide the capsule, or any other portions of the EAS 110, toward a landing location 114. In at least one embodiment, the landing location 114 is a predetermined landing location that is provided to the ALS 112, for example, prior to reentry. In at least one embodiment, the landing location 114 is a dynamically changing location, for example based on information related to the landing location 114, such as weather, personnel, and the like. Accordingly, in various embodiments, the landing location 114 may be predetermined or adjusted based one or more factors, which may be provided to the ALS 112 via a communication system and/or sensor information. It should be appreciated that a steerable parachute is shown for illustrative purposes only and that, in various embodiments, a sequence of devices may be deployed to slow the capsule below a threshold speed and that a steerable parachute may include one or none of the devices within the sequence.

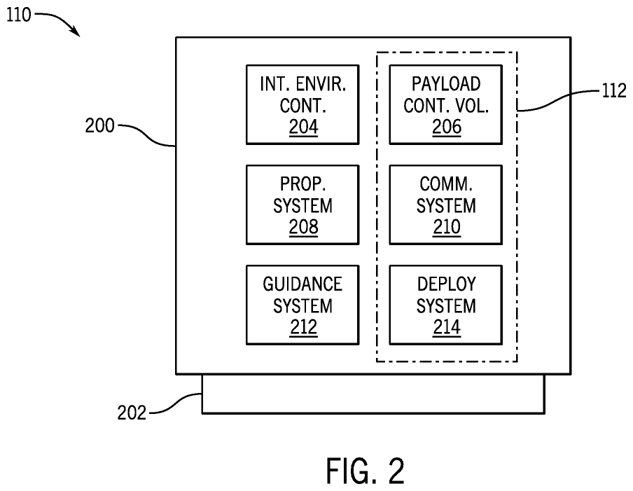

FIG. 2 is a schematic diagram of an embodiment of the EAS 110 that may be utilized with embodiments of the orbital delivery system 100. In this example, the EAS 110 includes various components to facilitate orbital or sub-orbital positioning, reentry, and navigation to a landing location. Moreover, one or more components of the EAS 110 may include a processor that executes instructions stored on machine-readable memory. The processor may receive the instructions from the memory, along with information from various sensors or various components associated with the EAS 110, to execute the instructions to perform one or more operations. Moreover, it should be appreciated that the ALS 112 may form at least a portion of the EAS 110. In at least one embodiment, the EAS 110 includes a body 200, such as a frustoconical capsule shape, a lifting body shape, an IRV, a MARV, or a MIRV, among other potential options. By way of example only, the body 200 may be shaped as a rigid blunt-cone capsule or in a lifting body configuration to facilitate maneuvering and/or slowing as the EAS 110 reenters the atmosphere. The body 200 may include one or more shielding components 202, which may help slow the body 200, thereby reducing velocity, and protecting against resultant reentry heating. In various embodiments, a portion of the forebody may include the shielding components 202. In at least one embodiment, a spherical section forebody includes an ablative heat shield. In at least one embodiment, various individual shield sections are arranged along the body 200. In at least one embodiment, different portions have different shielding materials. In at least one embodiment, different areas are shielded with greater or smaller quantities or shielding materials. It should be appreciated that a variety of different material types may be utilized and that the material may be selected based, at least in part, on expected operating conditions.

In the illustrated embodiment, the EAS 110 further includes an internal environmental control system 204. In various embodiments, the internal environmental control system 204 includes one or more components to maintain and control conditions within a payload containment volume 206 of the EAS 100, among other locations. In various embodiments, one or more systems or sub-systems may control and/or regulate gas pressure, temperature, containment, shielding (e.g., radiation, electromagnetic, heat, etc.), or various other systems within the EAS 100. It should be appreciated that various systems and sub-systems may be included, and that various components have been omitted, such as pumps, compressors, tanks, valves, sensors, and the like. For example, a compressor may be utilized to direct gas from a storage tank into the payload containment volume 206, which may stabilize the pressure and also cool the volume 206.

Various embodiments further include a propulsion system 208, which may include one or more boosters or directional control components. In an example, the propulsion system 208 includes a post-boost kick stage and/or payload bus. In at least one embodiment, the propulsion system 208 facilitates maneuvering or positioning of the body 200 along a trajectory and/or for reentry procedures. For example, the propulsion system 208 may be activated to initiate a reentry procedure by changing an orientation of the body 200 (e.g., such as positioning the shields 202 in a downward direction toward the earth), driving or otherwise moving the body 200 along a reentry trajectory, and then providing further maneuvering or positioning to facilitate reentry along a desired path or trajectory. It should be appreciated that the propulsion system 208 may include an inert cold gas, monopropellant, bi-propellant, or any combination thereof. It should be appreciated that the propulsion system 208 may further include one or more systems or sub-systems to facilitate steering within a prescribed or adapted reentry corridor.

In various embodiments, the EAS 110 also includes a communication system 210. In various embodiments, the communication system 210 enables the EAS 110 to send and/or receive information and instructions. For example, the communication system 210 may include one or more transceivers to send and transmit information over a variety of communication protocols, including but not limited to radio, optical links (e.g., optical intersatellite links, optical direct to ground link, etc.), or the like. Furthermore, the communication system 210 may transmit telemetry communication and further provide sensor information to a surface control sensor and/or a satellite controller in order to adjust and/or modify instructions for reentry. As noted above, in various embodiments, the EAS 110 may be deployed and remain in an orbital or sub-orbital position for an indefinite amount of time until a control command is received. It should be appreciated that while a communication system 210 is illustrated, various communication systems 210 may be used, for example, as redundancy in the event one or more systems become unavailable. As a result, the communication system 210 may facilitate rapid, on-demand deployment from EAS 110 units positioned in an orbital or sub-orbital position. It should be appreciated that the communication system 210 may be utilized, at least in part, to create at least one of an open-loop or closed-loop control system. By way of example only, the communication system 210 may send and/or receive information, such as instructions, to change a trajectory of the EAS 110, either during orbit or after reentry.

In this example, a guidance system 212 is also integrated into the EAS 110. The guidance system 212 may be utilized in combination with the propulsion system 208 to position the EAS 110 along a desired trajectory and/or to facilitate guidance to the landing location after entry, along with intermediate positions such as adjusting or changing position during reentry. Furthermore, the guidance system 212 may use one or more protocols, such as a GPS, inertial measurement unit, star tracker, or any other form of navigational sensing in order to facilitate positioning of the EAS 110 and/or reentry and landing of the EAS 110 or components of the EAS 110. It should be appreciated that while a single guidance system 212 is illustrated, various guidance systems 212 may be used, for example, as redundancy in the event one or more systems become unavailable.

In various embodiments, the EAS 110 includes a deployment system 214 to deploy one or more components of the ALS 112 in order to direct the body 200 to the landing location. As noted, the landing location may be a predetermined location or a dynamic, changing location. By way of example, the landing location may be changed en route, for example, based at least in part on external or internal guidance. In at least one embodiment, a feedback loop may be utilized for one or more sensors or communication devices. In at least one embodiment, the landing location may be changed based on a command received from an external source, such as a satellite or a ground control system, and as a result, the ALS 112 may maneuver to a different location. It should be appreciated that the landing location may be changed prior to reentry or after reentry. For example, the deployment system 214 may be activated by one or more sensors that facilitate a staged deployment of the ALS 112. By way of example only, a first sensor may determine a first speed threshold is reached to facilitate deployment of a first stage, then as a second speed threshold is reached a second stage may be deployed, and so forth until a final stage is deployed for final navigation to the landing location. In one or more embodiments, the deployment system 214 includes one or more frangible and/or sacrificial components that may be ejected or otherwise disconnected from the body 200, for example, by using a mortar release or the like. In various embodiments, components of the deployment system 214 may remain coupled to the body 200.

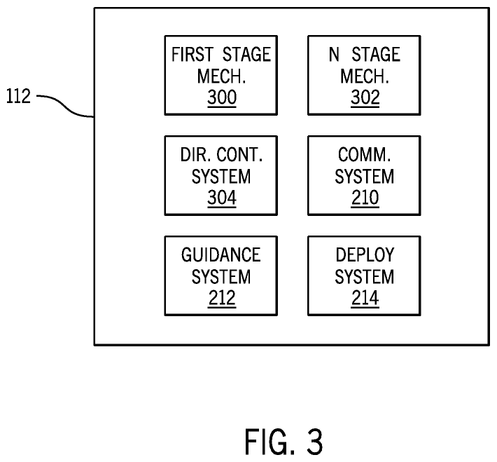

FIG. 3 is a schematic diagram of an embodiment of the ALS 112. It should be appreciated that embodiments may include one or more separate components for the ALS 112 and/or the ALS 112 may utilize components that were described as parts of the EAS 110, such as the guidance system 212, the communication 210, the deployment 214, and the like. For simplicity, these features are shown as being a portion of the ALS 112, but it should be appreciated that they may not be physically positioned within an enclosure representative of the ALS 112 and/or may be utilized with both the ALS 112 and the EAS 110. Moreover, it should be appreciated that the ALS 112 may form at least a portion of the EAS 110.

In various embodiments, the ALS 112 includes a series of mechanisms utilized to slow and/or guide the body 200 and/or payload volume 206 toward the landing location. In the example of FIG. 3, a first stage mechanism 300 is illustrated along with an N stage mechanism 302, illustrating that there may be any reasonable number of stages utilized to effectively slow and/or guide the body 200 and/or payload volume 206 toward the landing location. By way of example only, the one or more stages of mechanisms may include high-speed ballute (isotensoid) chute(s), drogue chute(s), pilot chute(s), main chute(s), and the like. Furthermore the one or more stages may also incorporate additional air-deployable systems, such as steerable quad copters, gliding vehicles, and the like. Accordingly, it should be appreciated that embodiments may be directed toward a variety of mechanisms, which may be deployed in series, responsive to reentry conditions.

In at least one embodiment, a direction control system 304 is utilized to guide and/or steer the payload volume 206 toward the landing location. The direction control system 304 may include a series of pulleys or levers that change an orientation of the one or more chutes to facilitate turns or banking toward the position. Additionally, in embodiments, the direction control system 304 may include motors that adjust one or more components, such as fins or rudders, to guide movement of the payload volume 206 via the mechanisms 300, 302. Moreover, as noted above, embodiments may include one or more quad copters or drones that include motors that may be activated and adjusted to steer the payload volume 206.

Furthermore, embodiments may include the above-described communication system 210, guidance system 212, and deployment system 214. For example, the communication system 210 may utilize one or more protocols to send or receive information to a base or controller. Additionally, the guidance system 212 may utilize one or more systems, such as a GPS transceiver, in order to identify a current location of the payload volume 206, identify a location of the landing location, and then navigate a course toward the position, for example via instructions transmitted to the direction control system 304. Additionally, the deployment system 214 may include sub-systems that initiate deployment of the various stages. For example, in an embodiment, the deployment system 214 may receive information from one or more sensors to determine whether a threshold condition is reached in order to initiate deployment of a different stage.

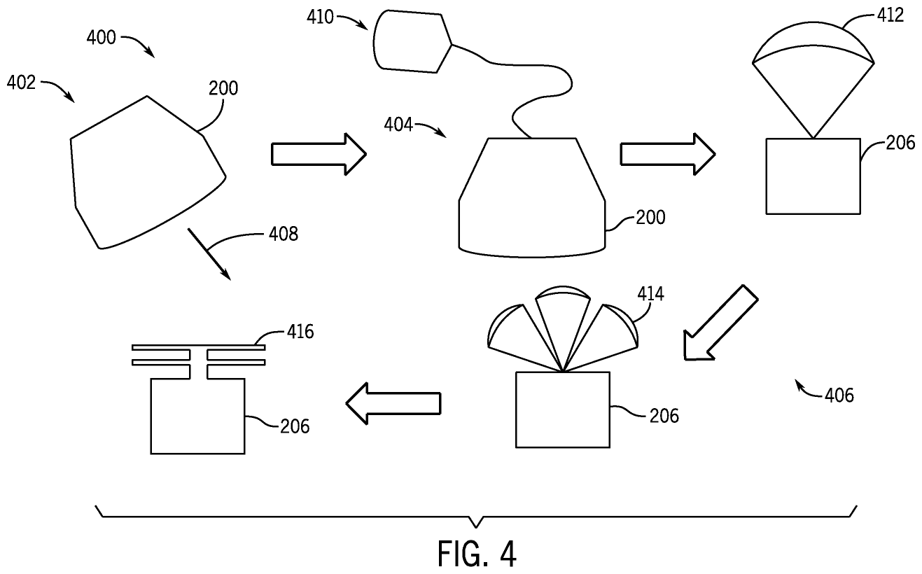

FIG. 4 is a schematic rendering of a sequence 400 for a reentry procedure, including an entry phase 402, a deployment phase 404, and then a series 406 of landing stages to direct the payload volume 206 toward the landing location. It should be appreciated that more or fewer steps may be included and, moreover, that the illustration of a capsule as the body 200 is for illustrative purposes and that a variety of different vehicles may be utilized. In this example, the entry phase 402 includes positioning or orienting the body 200 along a trajectory 408 for reentry. This trajectory 408 may be transmitted from one or more controllers, such as a ground controller or an in-orbit controller via the communication system 210. As a result, the body 200 may utilize the propulsion system 208 and/or the guidance system 212 in order to orient the body 200 such that the shielding 202 is arranged toward the earth for protection during reentry.

The deployment phase 404 includes the initiation of a first stage deployment of a mechanism for slowing or steering the body 200 and/or the payload volume 206. It should be appreciated that a first stage may include one or more mechanisms, such as chutes, to guide or position the body 200 while subsequent stages may be directed toward guidance of the payload volume 206 after removal from the body 200. As a result, less material may be delivered to the landing location, and sensitive electronics or components associated with the body 200 may be redirected to an alternative location for reuse or proper disposal/recycling. In this example, a first deployment mechanism 410 includes a chute to slow a velocity of the body 200 to enable a subsequent series to slow and guide the payload volume 206 toward the landing location. It should be appreciated that there may be one or more stages during the deployment phase 404, which may be defined by one or more properties of the body 200, such as a speed, altitude, or the like.

The landing series 406 includes a number of different mechanisms, as noted above, and may include different systems or sub-systems based on external conditions for the payload volume 206. For example, at a velocity exceeding a threshold, one or more systems may be better suited for slowing the payload volume 206 than others. As a result, one or more sensors may be used to determine properties of the payload volume 206. This information may be utilized by a controller, such as the deployment system 214 or another system, to determine a time period to activate subsequent stages within the series 406. In this example, a first stage 412 corresponds to a single chute, a second stage 414 corresponds to multiple chutes, and an nth stage 416 corresponds to a propeller-driven system, however, it should be appreciated that these are all shown for illustrative purposes only and that more or fewer systems, along with different types of systems, may be utilized in various embodiments. In this manner, a body in orbit or sub-orbit may reenter the atmosphere and be slowed to enable accurate guidance to a landing location.

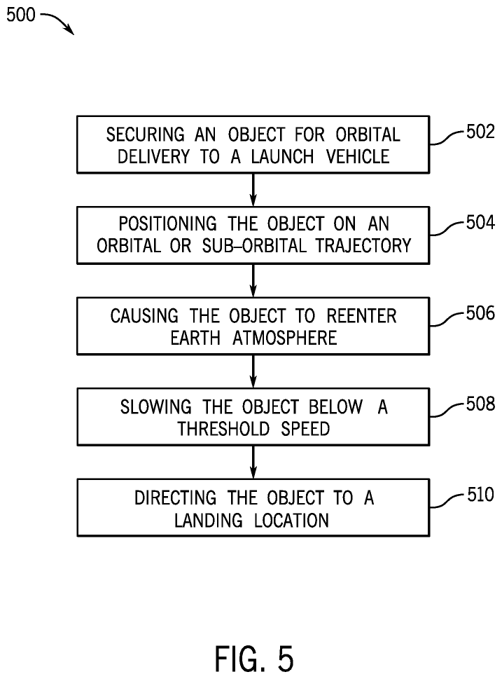

FIG. 5 is a flow chart of an embodiment of a method 500. It should be appreciated that for this method, and all methods described herein, that there may be more or fewer steps. Additionally, the steps may be performed in a different order, or in parallel, unless otherwise specifically stated. Furthermore, various steps of the method may be carried out on a processor in response to instructions stored on machine-readable memory. The processor may receive the instructions from the memory, along with information from various sensors, to execute the instructions to perform one or more steps of the method. In this example, an object for orbital delivery is secured to a launch vehicle 502. In various embodiments, the object may include one or more components of the EAS 110 to facilitate launching and positioning in an orbital or sub-orbital trajectory 504. For example, the EAS 110 may be equipped with sufficient shielding and environmental control components to withstand the pressures and temperatures associated with launch and orbital conditions. In at least one embodiment, the object reenters earth atmosphere 506. For example, a command signal may be transmitted to reenter atmosphere, which may include utilizing one or more propulsion systems to orient the EAS 110. In various embodiments, the object is slowed below a threshold speed 508. By way of example, a deployment system may engage one or more mechanisms, such as chutes, to slow the object down after reentry. The threshold speed may be particularly selected based on one or more design conditions, for example an operating range for various chutes. In at least one embodiment, the object is directed toward a landing location 510. For example, an onboard guidance or control system may be utilized to steer or otherwise navigate to a location, or within a vicinity or range of the location, for delivery of the object. It should be appreciated that this delivery may not be at a terminal velocity. In other words, delivery may be intended to maintain the integrity of the object, as opposed to delivering an explosive payload.

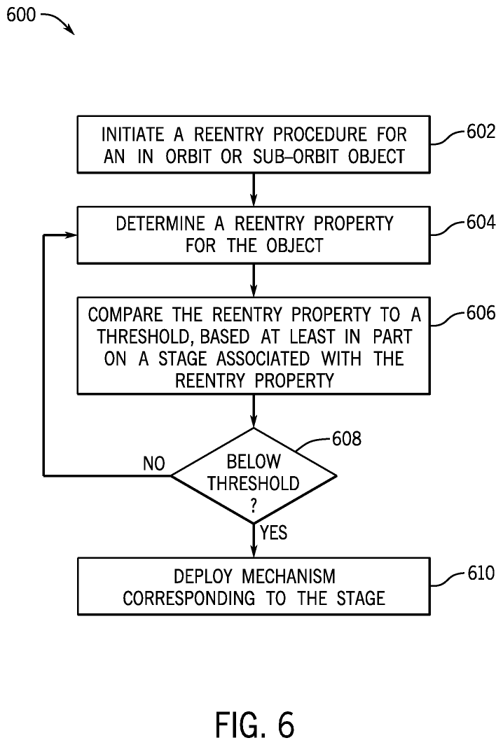

FIG. 6 is a flow chart of an embodiment of a method 600 for initiating one or more stages of a reentry procedure. In this example, a reentry procedure for an object in orbit or sub-orbit is initiated 602. In various embodiments, a reentry property for the object is determined 604. By way of example, the reentry property may be obtained from one or more sensors and may correspond to a speed, a trajectory, a location, an altitude, or the like. The entry property may be compared against a threshold 606. In various embodiments, the threshold may be associated with a stage of the reentry procedure. For example, a first stage may have a first threshold, a second stage may have a second threshold, and an nth stage may have an nth threshold. It may be determined whether the reentry property is below the threshold 608. If so, then a mechanism for that stage may be deployed 610, such as a chute or the like. If not, the reentry property may be monitored or evaluated until the threshold is met.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A delivery system, comprising:
a launch vehicle;
an exo-atmospheric system (EAS) adapted to couple to the launch vehicle to position the EAS along at least one of an orbital trajectory or a sub-orbital trajectory, the EAS having one or more control systems for maneuvering the EAS into a reentry trajectory; and
an atmospheric landing system associated with the EAS, the atmospheric landing system being deployable responsive to reentry of the EAS into an earth atmosphere, the atmospheric landing system directing at least a portion of the EAS to a landing location.

2. The delivery system of claim 1, further comprising:
a propulsion system associated with the EAS, the propulsion system adjusting a trajectory of the EAS.

3. The delivery system of claim 2, wherein the propulsion system includes at least one of an inert cold gas, a monopropellant, or a bi-propellant.

4. The delivery system of claim 1, wherein the atmospheric landing system further comprises:
one or more controllable chutes for slowing a velocity of payload and for directing the payload toward the landing location, the one or more controllable chutes being deployable responsive to a property of the EAS.

5. The delivery system of claim 4, wherein the one or more controllable chutes include at least of a high-speed ballute chute, a drogue chute, a pilot chute, or a main chute.

6. The delivery system of claim 4, wherein the one or more controllable chutes are deployable in a predetermined sequence.

7. The delivery system of claim 1, wherein at least a portion of the EAS is arranged within a body, the body being at least one of a capsule, a lifting body, an inflatable reentry vehicle (IRV), a maneuverable reentry vehicle (MARV), or multiple independently targetable reentry vehicles (MIRV).

8. The delivery system of claim 1, further comprising:
a communication system, the communication system configured to send or receive information to adjust a current trajectory of the EAS toward the reentry trajectory.

9. An exo-atmospheric system (EAS), comprising:
a payload volume;
a propulsion system configured to adjust a trajectory of the EAS; and
an atmospheric landing system, the atmospheric landing system being deployable, responsive to a delivery phase, to guide at least a portion of the EAS toward a landing location.

10. The system of claim 9, wherein the propulsion system positions the EAS along an orbital or sub-orbital trajectory and, responsive to an instruction, orients the EAS for reentry.

11. The system of claim 9, further comprising:
a body, the body being selectively shielded via one or more shields, the one or more shields operational to reduce a velocity of the body upon reentry.

12. The system of claim 9, further comprising:
an internal environmental control system, the internal environmental control system regulating at least one of a temperature or a pressure of the payload volume.

13. The system of claim 9, further comprising:
a deployment system for activating at least a portion of the atmospheric landing system, the deployment system transitioning at least a portion of the atmospheric landing system from an interior location to an exterior location.

14. The system of claim 9, wherein the atmospheric landing system comprises:
one or more landing vehicles for reducing a velocity of at least the payload volume, at least one of the one or more landing vehicles being a steerable landing vehicle to direct the payload volume toward the landing location.

15. The system of claim 14, wherein the one or more landing vehicles include at least one of a high-speed ballute chute, a drogue chute, a pilot chute, or a main chute.

16. The system of claim 9, further comprising:
a communication system, the communication system configured to send or receive information to adjust a current trajectory of the EAS toward the reentry trajectory.

17. A method, comprising:
initiating a reentry procedure for an object along an orbital or sub-orbital trajectory;
determining a stage associated with the reentry procedure;
determining a reentry property, for the stage, is below a threshold; and
deploying a landing vehicle corresponding to the stage.

18. The method of claim 17, further comprising:
determining, after deploying the landing vehicle, a second stage;
determining a second reentry property, for the second stage, is below a threshold; and
deploying a second landing vehicle corresponding to the second stage, the second landing vehicle being different from the landing vehicle.

19. The method of claim 17, further comprising:
coupling the object to a launch vehicle; and
positioning the object along the orbital or sub-orbital trajectory;
receiving, from the object, location information; and
determining, based at least in part on the location information, a position of the object.

20. The method of claim 17, further comprising:
receiving a signal to initiate the reentry procedure; and
adjusting a position of the object, via a propulsion system, responsive to the signal.
